(19) United States
(12) Patent Application Publication
(10) Pub. No.: US 2016/0155546 A1
(43) Pub. Date: Jun. 2, 2016

(54) THERMISTOR ELEMENT

(71) Applicant: Murata Manufacturing Co., Ltd., Nagaokakyo-shi (JP)

(72) Inventors: Tadamasa MIURA, Nagaokakyo-shi (JP); Jun YANAGIHARA, Nagaokakyo-shi (JP); Eisuke TASHIRO, Nagaokakyo-shi (JP)

(21) Appl. No.: 15/016,852

(22) Filed: Feb. 5, 2016

Related U.S. Application Data
(63) Continuation of application No. PCT/JP2014/055259, filed on Mar. 3, 2014.

(30) Foreign Application Priority Data
Aug. 8, 2013 (JP) 2013-164902

(51) Int. Cl. H01C 7/00; H01C 7/04; H01C 1/148; H01C 1/14

(52) U.S. Cl. CPC H01C 7/008; H01C 1/1413; H01C 7/041; H01C 1/148

(57) ABSTRACT

In an thermistor element, a main body includes a first thermistor section and a second thermistor section stacked on the first thermistor section. A first internal electrode and a second internal electrode vertically sandwich the first thermistor section. A second internal electrode and a third internal electrode vertically sandwich the second thermistor section. A temperature coefficient α_{TH1} of a portion between the first and second internal electrodes in the first thermistor section is different from a temperature coefficient α_{TH2} of a portion between the second and third electrodes in the second thermistor section.

### BACKGROUND OF THE INVENTION

1. Field of the Invention

The present invention relates to a thermistor element of a first thermistor section with a second thermistor section stacked thereon.

2. Description of the Related Art

With performance improvement of electronic devices in recent years, electronic components which generate large amounts of heat (hereinafter, referred to as heat-generating components) have been more often used for the electronic components. Therefore, the internal temperatures of the electronic components or the housing surface temperatures of the electronic components are likely to be increased. It is to be noted that examples of the heat-generating components include CPUs and power amplifiers.

In order to suppress the increase in temperature as mentioned above, the electronic components are provided with a temperature sensing circuit 101 and an IC 102 as illustrated in FIG. 11. Each part will be described in detail below.

The temperature sensing circuit 101 has a thermistor element 103 and a fixed resistive element 104 connected in series. In addition, an output terminal 105 is extended from a connection line between the thermistor element 103 and the fixed resistive element 104. A constant voltage V_{CC} generated in a constant voltage circuit, not shown, is supplied across both ends of this temperature sensing circuit 101.

The thermistor element 103 is disposed to be thermally bonded to a heat-generating component 106 to be subjected to temperature sensing. In addition, this thermistor element 103 has a negative temperature coefficient, that is, resistance-temperature characteristics of resistance value R_{TH} decreasing with increase in ambient temperature (that is, the surface temperature of the heat-generating component 106). The resistance-temperature characteristics are preferably substantially linear. This type of thermistor element 103 includes a laminated NTC thermistor as presented in, for example, Japanese Patent Application Laid-Open No. 2006-269659.

The fixed resistive element 104 has a resistance value R_{F}.

In the temperature sensing circuit 101 configured as described above, the resistance value R_{TH} of the thermistor element 103 changes in a substantially linear manner, depending on the change in the surface temperature T_{S} of the heat-generating component 106. Therefore, from the output terminal 105, a voltage V_{OUT} (=V_{CC}·R_{TH}/(R_{TH}+R_{F})) correlated with the surface temperature T_{S} is output to the IC 102. The IC 102 controls the performance of the heat-generating component 106 depending on the output voltage V_{OUT}. Specifically, when the output voltage V_{OUT} is higher than a predetermined reference value, the performance of the heat-generating component 106 is decreased.

However, because the temperature sensing circuit 101 shown in FIG. 11 includes the thermistor element 103 and the fixed resistive element 104, there is a problem that the space for mounting the two elements is required around the heat-generating component 106. In particular, recent electronic devices have a large number of electronic components mounted densely, and it is thus difficult to secure the space for mounting the two elements.

### SUMMARY OF THE INVENTION

Therefore, preferred embodiments of the present invention provide a thermistor element that is able to be disposed in a limited space.

A first aspect of various preferred embodiments of the present invention is a thermistor element including a main body including a first thermistor section with first and second principal surfaces opposed to each other, and a second thermistor section with third and fourth principal surfaces opposed to each other, the second thermistor section stacked on the first thermistor section so that the third principal surface is brought into contact with the second principal surface; a first electrode located on the first principal surface and exposed externally from the main body; a second electrode interposed between the second and third principal surfaces and exposed externally from the main body, the second electrode overlapped with the first electrode in planar view from a first direction of the second thermistor section to the first thermistor section; and a third electrode located on the fourth principal surface and exposed externally from the main body, the third electrode overlapped with the second electrode in planar view from the first direction.

In this case, the temperature coefficient α_{TH1} of the portion between the first and second electrodes in the first thermistor section is different from the temperature coefficient α_{TH2} of the portion between the second and third electrodes in the second thermistor section.

In the thermistor element according to the aspect mentioned above, a constant voltage is supplied to the first electrode and the third electrode. Accordingly, a divided voltage correlated with the ambient temperature of the thermistor element is supplied from the second electrode. As just described, the thermistor element alone is able to detect the ambient temperature, thus making it possible to dispose the element in more limited space.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of the appearance of a thermistor element according to a first preferred embodiment of the present invention.

FIG. 2 is a vertical cross-sectional view of the thermistor element shown in FIG. 1.

FIG. 3 is a perspective view and an exploded perspective view illustrating the main body shown in FIG. 1.

FIG. 4 is a perspective view illustrating the first, second and third internal electrodes shown in FIG. 2.

FIG. 5 is a pattern diagram illustrating an evaluation board for an evaluation sample.

FIG. 6 is a graph showing temperature characteristics of the output voltage for the evaluation sample.

FIG. 7 is a pattern diagram illustrating a second configuration example of the second external electrode shown in FIG. 1.

FIG. 8 is a pattern diagram illustrating a third configuration example of the second external electrode shown in FIG. 1.

FIG. 9 is a perspective view of the appearance of a thermistor element according to a second preferred embodiment of the present invention.

FIG. 10 is an exploded perspective view of the main body shown in FIG. 9.

FIG. 11 is a diagram illustrating the configuration of a conventional temperature sensing circuit.

### DETAILED DESCRIPTION OF THE PREFERRED EMBODIMENTS

### First Preferred Embodiment

A thermistor element 1 according to a first preferred embodiment of the present invention will be described in detail below with reference to the respective figures.

First, the L axis, W axis, and T axis shown in some of the drawings will be described. The T axis direction indicates a direction in which a second thermistor section 23 is stacked on the basis of a first thermistor section 22, and refers to a first example of a first direction. The L axis direction indicates a horizontal direction of the thermistor element 1, and refers to a first example of a second direction. The W axis direction indicates a front-back direction of the thermistor element 1, and refers to a first example of a third direction. Hereinafter, for the sake of explaining the present preferred embodiment, the first direction, the second direction, and the third direction are denoted by T, L, and W as reference symbols.

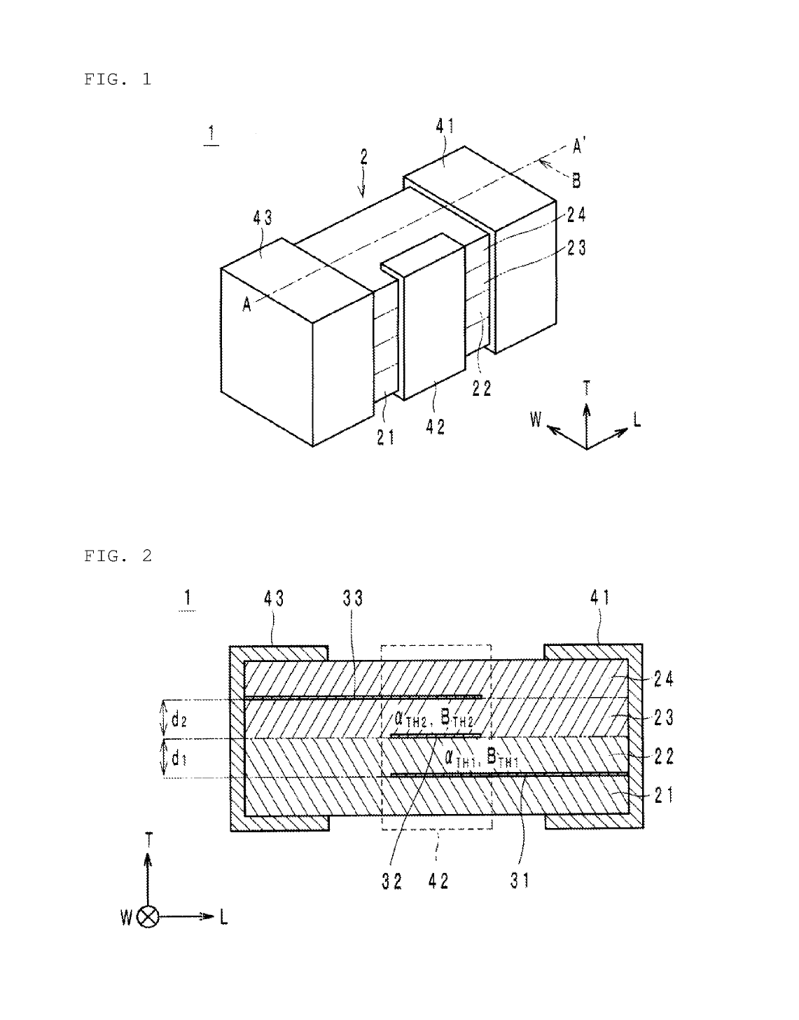

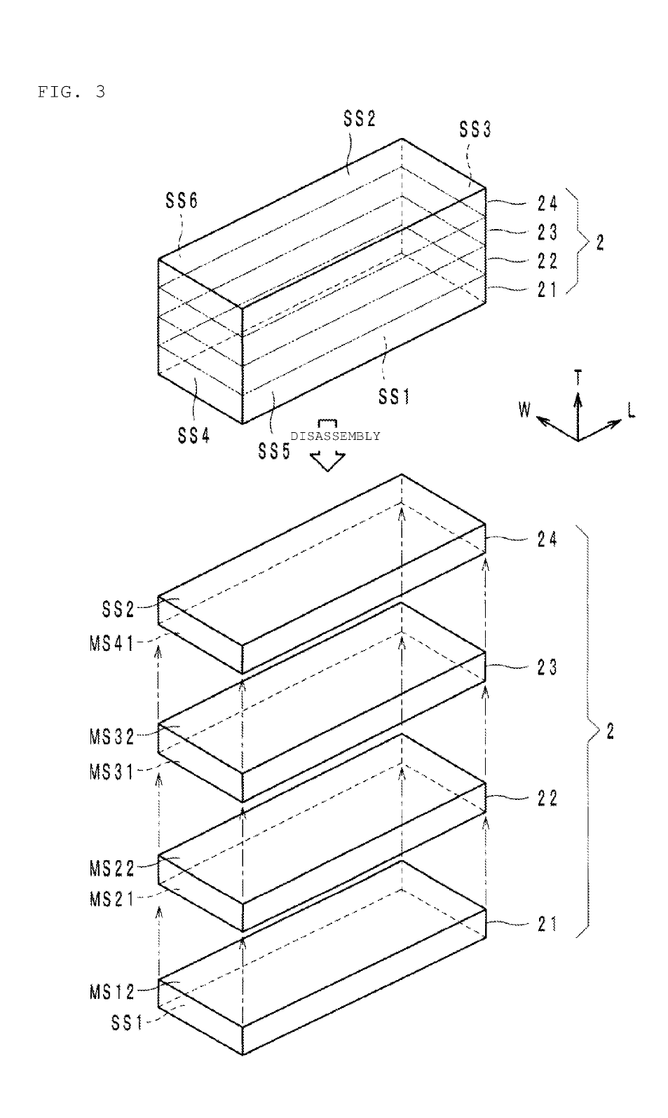

FIG. 1 is a perspective view of a finished product of the thermistor element 1. In addition, FIG. 2 is a vertical cross-sectional view of the thermistor element 1 shown in FIG. 1. The vertical cross-sectional view of FIG. 2 is a cross section obtained by cutting the thermistor element 1 along a vertical center plane parallel to a TL plane, which includes a dashed-dotted line A-A′ (see FIG. 1), as viewed from the direction of an arrow B parallel to the third direction W. In FIGS. 1 and 2, the thermistor element 1 is, for example, an NTC thermistor with a negative temperature coefficient, which includes at least a thermistor main body 2, a first internal electrode 31, a second internal electrode 32, a third internal electrode 33, a first external electrode 41, a second external electrode 42, and a third external electrode 43. It is to be noted that the external electrode 42 is shown by a dashed line in an imaginary fashion in FIG. 2.

The main body 2 preferably has a cuboid or substantially cuboid shape including six side surfaces SS1 to SS6 as shown in the upper section of FIG. 3. The side surfaces SS1, SS2 define and function as, for example, the bottom surface and top surface of the main body 2, which are mutually opposed in the first direction T. The side surfaces SS3, SS4 define and function as, for example, the right end surface and left end surface of the main body 2, which are mutually opposed in the second direction L. The side surfaces SS5, SS6 define and function as, for example, the front surface and back surface of the main body 2, which are mutually opposed in the third direction W.

In addition, as for the main body 2, the dimension in the L axis direction (hereinafter, referred to as an L dimension) is about 0.56 mm, the dimension in the W axis direction (hereinafter, referred to as a W dimension) is about 0.28 mm, and the dimension in the T axis direction (hereinafter, referred to as a T dimension) is about 0.28 mm, for example. It is to be noted that the L dimension, the W dimension, and the T dimension are all designed target values, and are not always about 0.56 mm, about 0.28 mm, and 0.28 mm, with tolerances.

In addition, the main body 2 includes, as shown in the upper and lower sections of FIG. 3, a third thermistor section 21, the first thermistor section 22, the second thermistor section 23, and a fourth thermistor section 24 that are stacked in this order from bottom up. Specifically, there are a first principal surface MS 21 of the thermistor section 22 in contact on a fifth principal surface MS 12 of the thermistor section 21, a third principal surface MS 31 of the thermistor section 23 in contact on a second principal surface MS 22 of the thermistor section 22, and a sixth principal surface MS 41 of the thermistor section 24 in contact on a fourth principal surface MS 32 of the thermistor section 23. It is to be noted that the boundaries between two thermistor sections that are adjacent to each other in the first direction T are shown by dashed-two dotted lines in an imaginary fashion in the upper section of FIG. 3.

Next, the thermistor sections 22, 23 will be described in detail.

First, the thermistor section 22 is a section obtained preferably by mixing and sintering of two to four types of oxides selected from a group including manganese (Mn), nickel (Ni), iron (Fe), cobalt (Co), and copper (Cu), etc. (hereinafter, referred to as a sintered oxide section). This thermistor section 22 has a negative temperature coefficient α_{TH1}, and has a resistance value that decreases in a substantially linear manner with increase in temperature in the temperature range in which the thermistor element 1 is used. In addition, the B constant of the thermistor section 22 is B(25/50)_{TH1}, which is the B constant of the thermistor section 22 obtained from the resistance value at approximately 25° C. and the resistance value at approximately 50° C. In addition, the thickness of the thermistor section 22 along the first direction T is approximately d₁.

Next, the relationship between a temperature coefficient α and the B constant will be described. The B constant is obtained from the following Formula 1, and the α is obtained from the following Formula 2.

$$\begin{matrix}Formula 1 & \\ B = \frac{2.3026 ( log R - log {R}_{0} )}{\frac{1}{T} - \frac{1}{{T}_{0}}} & ( 1 )\end{matrix}$$

In the above Formula 1, R₀ and R [kΩ] represent resistance values at an ambient temperature T₀ and T [K].

$$\begin{matrix}Formula 2 & \\ α = - \frac{B}{{T}^{2}} \cdot 100 [ \% / ° C . ] & ( 2 )\end{matrix}$$

As described above, the temperature coefficient α is correlated with the B constant.

The thermistor section 23 preferably is a sintered oxide section of two to four types selected from the group mentioned above. However, the thermistor section 23 has a different composition from the thermistor section 22. In addition, this thermistor section 23 has a negative temperature coefficient α_{TH2}, and has a resistance value that decreases in a substantially linear manner with increase in temperature at least in the operating temperature range mentioned above. In addition, the B constant of the thermistor section 23 is B(25/50)_{TH2}, and the thickness thereof along the first direction T is approximately d₂. In this regard, α_{TH2} has a different value from α_{TH1}, and B(25/50)_{TH2} has a different value from B(25/50)_{TH1}. d₁ and d₂ which may have the same value or different values, are designed appropriately for preferred values in accordance with the specification of the thermistor element 1.

It is to be noted that in the present preferred embodiment, for the reason of manufacturing method, the third thermistor section 21 preferably has the same sintered oxide body as the first thermistor section 22, and the fourth thermistor section 24 preferably has the same sintered oxide body as the second thermistor section 23.

The internal electrodes 31 to 33 are flat electrodes that are produced by applying and firing a conductive paste containing silver (Ag)-palladium (Pd) as a main constituent. The respective internal electrodes 31 to 33 will be described in detail below.

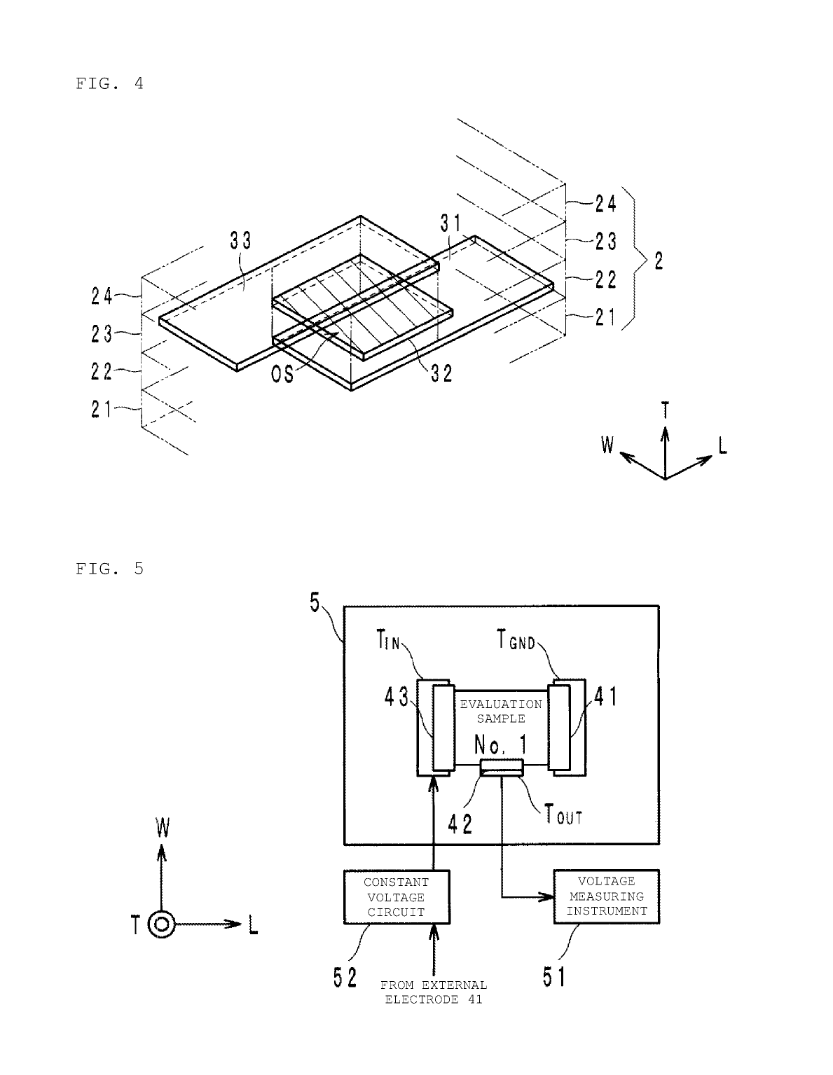

In this regard, FIG. 4 is a perspective view illustrating the internal electrodes 31 to 33 shown in FIG. 2. In FIG. 4, the thermistor sections 21 to 24 are partially shown by dashed-two dotted lines in order to clarify the arrangement relationship among the internal electrodes 31 to 33. In FIG. 4, the internal electrode 31, the internal electrode 32, and the internal electrode 33 are respectively interposed between the thermistor sections 21, 22, between the thermistor sections 22, 23, and between the thermistor sections 23, 24. These internal electrodes 31 to 33 each preferably have, as shown in FIG. 4, a rectangular or substantially rectangular shape in planar view from the first direction T, for example. The respective internal electrodes 31 to 33 will be further specifically described below.

The internal electrode 31, which is a first example of a first electrode, extends in a strip shape from the side surface SS3 (see FIG. 3) of the main body 2, in a direction opposite to the second direction L between the thermistor sections 21, 22 (in other words, on the first principal surface MS21), as shown in FIG. 2. In addition, the internal electrode 31 is, for electrical connection to the after-mentioned external electrode 41, exposed from the main body 2 at the right end (that is, a side end in a positive direction in the second direction L), but the other portion is covered with the main body 2.

The internal electrode 32, which is a first example of a second electrode, extends from the side surface SS5 (see FIG. 3) of the main body 2, in the third direction W between the thermistor sections 22, 23 (in other words, between the second principal surface MS22 and the third principal surface MS31). In addition, the internal electrode 32 is, for electrical connection to the after-mentioned external electrode 42, exposed from the main body 2 at the side surface SS5 (that is, the front surface), but the other portion is covered with the main body 2. Further, to explain the further specific position, the internal electrode 32 is spaced apart in the first direction T just at a distance of approximately d₁ (see FIG. 2) on the basis of the internal electrode 31, and overlapped with the internal electrode 31 just of an area OS (see a shaded area in FIG. 4) in planar view from the first direction T. In this regard, the overlap area OS is designed appropriately for preferred values in accordance with the specification of the thermistor element 1. It is to be noted that the internal electrodes 31, 33 also have the overlap portion in fact, but for the convenience of illustration, the internal electrode 32 is only shown with hatching in FIG. 4.

The internal electrode 33, which is a first example of a third electrode, extends in a strip shape from the side surface SS4 (see FIG. 3) of the main body 2, in the second direction L between the thermistor sections 23, 24 (in other words, on the fourth principal surface MS32), as shown in FIG. 2. In addition, the internal electrode 33 is, for electrical connection to the after-mentioned external electrode 43, exposed from the main body 2 at the left end (that is, a side end in a negative direction in the second direction L), but the other portion is covered with the main body 2. Further, to explain the further specific position, the internal electrode 33 is spaced apart in the first direction T just at a distance of approximately d₂ (see FIG. 2) on the basis of the internal electrode 32, and overlapped with the internal electrode 32 just of the area OS (see FIG. 4) in planar view from the first direction T. It is to be noted that while the internal electrodes 31, 33 are explained as preferably being overlapped with the internal electrode 32 of the same area OS in the present preferred embodiment, the present invention is not limited to the present preferred embodiment, but the electrodes may have overlaps of different areas with each other.

Again, reference is made to FIG. 1. The external electrodes 41 to 43 each preferably include a base layer containing Ag as its main constituent, a nickel (Ni) plated layer formed on the base layer, and a tin (Sn) plated layer formed on the Ni plated layer. The respective external electrodes 41 to 43 will be described in detail below.

The external electrode 41 covers the right end of the main body 2. More specifically, the electrode covers the entire side surface SS3 and right ends of the side surfaces SS1, SS2, SS5, SS6 (see FIG. 3). In addition, as mentioned above, the external electrode 41 is electrically connected to the internal electrode 31.

The external electrode 42 vertically crosses a central portion of the side surface SS5 (see FIG. 3) in the L axis direction, and has no contact with external electrode 41. In addition, as mentioned above, the external electrode 42 is electrically connected to the internal electrode 32.

The external electrode 43 covers the left end of the main body 2, and has no contact with the external electrodes 41, 42. More specifically, the electrode covers the entire side surface SS4 and left ends of the side surfaces SS1, SS2, SS5, SS6 (see FIG. 3). In addition, as mentioned above, the external electrode 43 is electrically connected to the internal electrode 33.

A non-limiting example of manufacturing the thermistor element 1 preferably includes the following steps (1) to (7). It is to be noted that while the steps for manufacturing one thermistor element 1 will be described below, a large quantity of thermistor elements 1 is actually manufactured in a batch.

(1) First, as raw materials for the thermistor sections 21, 22, for example, oxides of Mn, Ni, Fe, and Co are weighed so as to provide a predetermined combination. In this regard, the predetermined combination herein refers to, for example, a combination such that the sintered thermistor sections 21, 22 have a resistivity of about 10³Ωcm.

It is to be noted that this composition refers to a composition as listed in No. 1 in Table 1 described later. The weighed raw materials are sufficiently subjected to wet grinding with a ball mill with the use of a grinding medium such as zirconia. Thereafter, the ground raw materials are subjected to calcination at a predetermined temperature, thus providing a first ceramic powder.

(2) Next, the first ceramic powder is, with the addition of an organic binder thereto, subjected to mixing in a wet way. Thus, slurry is obtained which has ceramic particles mixed therein. From this slurry, a first ceramic green sheet is produced by a doctor blade method or the like. In this regard, the thickness, etc. of the first ceramic green sheet are adjusted so that the thickness is preferably approximately 40 μm after firing. Onto this first ceramic green sheet, a conductive paste for the internal electrodes 31, 32, which contains Ag—Pd as its main constituent, is applied by a doctor blade method or the like, thereby forming a first mother sheet.

(3) In addition, as raw materials for the thermistor sections 23, 24, for example, oxides of Mn, Ni, Fe, and Ti are weighed so as to provide a predetermined combination. In this regard, the predetermined combination herein refers to, for example, a combination such that the sintered thermistor sections 23, 24 have a resistivity of about 10⁴Ωcm. It is to be noted that this composition refers to a composition as listed in No. 1 in Table 1 described later. The weighed raw materials are, as with the step (1), sufficiently subjected to wet grinding, and then subjected to calcination at a predetermined temperature. Thus, a second ceramic powder is obtained.

(4) Next, from the second ceramic powder, in the same approach as in the step (2), slurry is obtained which has ceramic particles mixed therein, and a second ceramic green sheet is produced such that the thickness is approximately 40 μm after firing. Onto this second ceramic green sheet, a conductive paste for the internal electrode 33, which contains Ag—Pd as its main constituent, is applied to form a second mother sheet.

(5) Next, after stacking a predetermined number of first ceramic green sheets in the first direction T, the single first mother sheet with the applied conductive paste for the internal electrode 31 is stacked. Thus, portions are formed which are supposed to define and function as the ceramic portion 21 and the internal electrode 31 after firing. After stacking, on the portions, a predetermined number of first ceramic green sheets in the first direction T, the single first mother sheet with the applied conductive paste for the internal electrode 32 is stacked. Thus, portions are formed which are supposed to define and function as the ceramic portion 22 and the internal electrode 32 after firing. After stacking thereon a predetermined number of second ceramic green sheets in the first direction T, the single second mother sheet with the applied conductive paste for the internal electrode 33 is stacked. A predetermined number of second ceramic green sheets is further stacked thereon in the first direction T. As a result, an unfired stacked body is completed which defines and functions as the main body 2 with the internal electrodes 31 to 33 embedded therein. This unfired stacked body is subjected to vertical pressing by pressure bonding. It is to be noted that the thickness of the unfired stacked body in the first direction T (that is, the T dimension) preferably is adjusted to be about 0.28 mm after firing.

(6) The unfired stacked body is cut so that the L dimension and W dimension of the main body 2 after firing are respectively about 0.56 mm and about 0.28 mm. The cut stacked body is housed in a zirconia sagger, and then subjected to binder removal treatment, and further to firing at a predetermined temperature (for example, about 1100° C.). Thus, a sintered body is obtained.

(7) Base layers containing Ag as its main constituent are formed respectively on both ends of the sintered body in the second direction, and a central portion of the side surface SS5 thereof, through film formation by a dip method and then baking in the atmosphere at approximately 800° C. Thereafter, on the respective base layers, Ni plating layers and Sn plating layers are formed in this order by, for example, an electrolytic barrel plating method. Thus, the external electrodes 41 to 43 are formed.

The thermistor element 1 is preferably completed in accordance with the steps (1) to (7) described above.

The inventors prepared thermistor elements 1 from respective combinations listed in No. 1 to No. 12 of Table 1 below as composition systems for the thermistor sections 22, 23 (hereinafter, referred to as evaluation samples No. 1 to No. 12). The evaluation sample No. 1 will be described in detail as a representative of the twelve types mentioned above.

TABLE 1
Details of First and Second Thermistor Sections 22, 23
and Electrical Properties of Thermistor Main Body 2

| | First Thermistor Section 22 | | | Second Thermistor Section 23 | | | | |
|---|---|---|---|---|---|---|---|---|
| | | Resistance | B (25/50) | | Resistance | B (25/50) | Electrical | |
| | Composition | Value | TH1 | Composition | Value | TH2 | Properties | |
| No. | System | RTH1 [Ω] | [K] | System | RTH2 [Ω] | [K] | ΔmV/K | R² |
| 1 | Mn—Ni—Fe—Co | 10000 | 3380 | Mn—Ni—Fe—Ti | 47000 | 4050 | 3.2 | 0.998 |
| 2 | Mn—Ni—Fe—Co | 10000 | 3380 | Mn—Ni—Co—Cu | 100 | 3150 | 0.03 | 0.989 |
| 3 | Mn—Ni—Fe—Co | 10000 | 3380 | Mn—Ni—Co—Cu | 1000 | 3150 | 0.9 | 0.993 |
| 4 | Mn—Ni—Fe—Co | 10000 | 3380 | Mn—Ni—Al | 100000 | 4250 | 2.4 | 1 |
| 5 | Mn—Ni—Fe—Ti | 47000 | 4050 | Mn—Ni—Al | 100000 | 4250 | 1.2 | 0.991 |
| 6 | Mn—Co—Fe—Al | 100000 | 4450 | Mn—Ni—Al | 100000 | 4250 | 1.2 | 0.994 |
| 7 | Mn—Ni—Fe—Co | 10000 | 3380 | Mn—Co—Fe—Al | 100000 | 4450 | 3 | 0.994 |
| 8 | Mn—Ni—Fe—Co | 10000 | 3380 | Mn—Co—Fe—Al | 47000 | 4450 | 5.1 | 0.998 |
| 9 | Mn—Ni—Fe—Co | 10000 | 3380 | Mn—Ni—Co—Al | 10000 | 3950 | 3.9 | 0.976 |
| 10 | Mn—Ni—Fe—Ti | 47000 | 4050 | Mn—Co—Fe—Al | 47000 | 4450 | 3 | 0.996 |
| 11 | Mn—Ni—Fe—Co | 10000 | 3380 | Mn—Ni—Fe—Ti | 10000 | 4050 | 5.4 | 0.98 |
| 12 | Mn—Ni—Fe—Co | 47000 | 3380 | Mn—CO—Fe—Al | 47000 | 4450 | 8.1 | 0.987 |

In regard to the evaluation sample No. 1, the first thermistor section 22 has a composition system of Mn—Ni—Fe—Co. In regard to the thermistor section 22, the resistance value R_{TH1} at approximately 25° C. is 10000Ω, and the B(25/50)_{TH1} is 3380 K. In addition, in regard to the second thermistor section 23 of the sample, the composition system is Mn—Ni—Fe—Ti. In addition, in regard to the thermistor section 23, the resistance value R_{TH2} at approximately 25° C. is 47000Ω, and the B(25/50)_{TH2} is 4050 K.

Furthermore, the inventors prepared an evaluation board 5 for the evaluation sample No. 1 as shown in FIG. 5 to measure electrical properties for each evaluation sample. For example, the evaluation sample No. 1 as a temperature sensing circuit is mounted on the evaluation board 5, and a voltage measuring instrument 51 and a constant voltage circuit 52 are provided around the evaluation sample No. 1. Each portion will be described in detail below.

For each evaluation sample No. 1, the external electrode 43, the external electrode 41, and the external electrode 42 are electrically connected, with a mounting solder containing Sn—Ag—Cu, respectively to an input terminal electrode T_{IN}, a ground electrode T_{GND}, and an output terminal electrode T_{OUT}, which are provided in the evaluation board 5. A constant voltage V_{CC} (for example, 3 [V]) generated in the constant voltage circuit 52 is supplied between the external electrodes 41, 43.

The voltage measuring instrument 51 electrically connected to the output terminal electrode T_{OUT} is configured to be able to measure an output voltage V_{OUT} from the output terminal electrode T_{OUT} when a constant voltage V_{CC} is supplied.

The ambient temperature of the thermistor element 1 on the evaluation board 5 described above is varied in the operating temperature range (from about −40° C. to about 125° C.) of the evaluation sample No. 1 through the use of, for example, a temperature cycling bath or the like. In addition, when the constant voltage V_{CC} is applied between the external electrodes 41, 42, electric fields are formed respectively between the internal electrodes 33, 32 and between the internal electrodes 32, 31 in the thermistor element 1. In addition, when the ambient temperature of the thermistor element 1 varies while the constant voltage V_{CC} is applied, the resistance value R_{TH2} of the portion of the thermistor section 23 sandwiched between the internal electrodes 33, 32 varies depending on the temperature coefficient α_{TH2}. Likewise, the resistance value R_{TH1} of the portion of the thermistor section 22 sandwiched between the internal electrodes 32, 31 varies depending on the temperature coefficient α_{TH1}. Thus, the equivalent circuit of the thermistor element 1 substantially has series-connected two variable resistances that change in resistance value R_{TH2}, R_{TH1} depending on the ambient temperature. The external electrode 42 is electrically connected to the internal electrode 32, and thus, from the external electrode 42, a divided voltage (≈V_{CC}·R_{TH2}/(R_{TH1}+R_{TH2})) of the applied voltage V_{CC} is output as the voltage V_{OUT}. The voltage measuring instrument 51 measures this output voltage V_{OUT}.

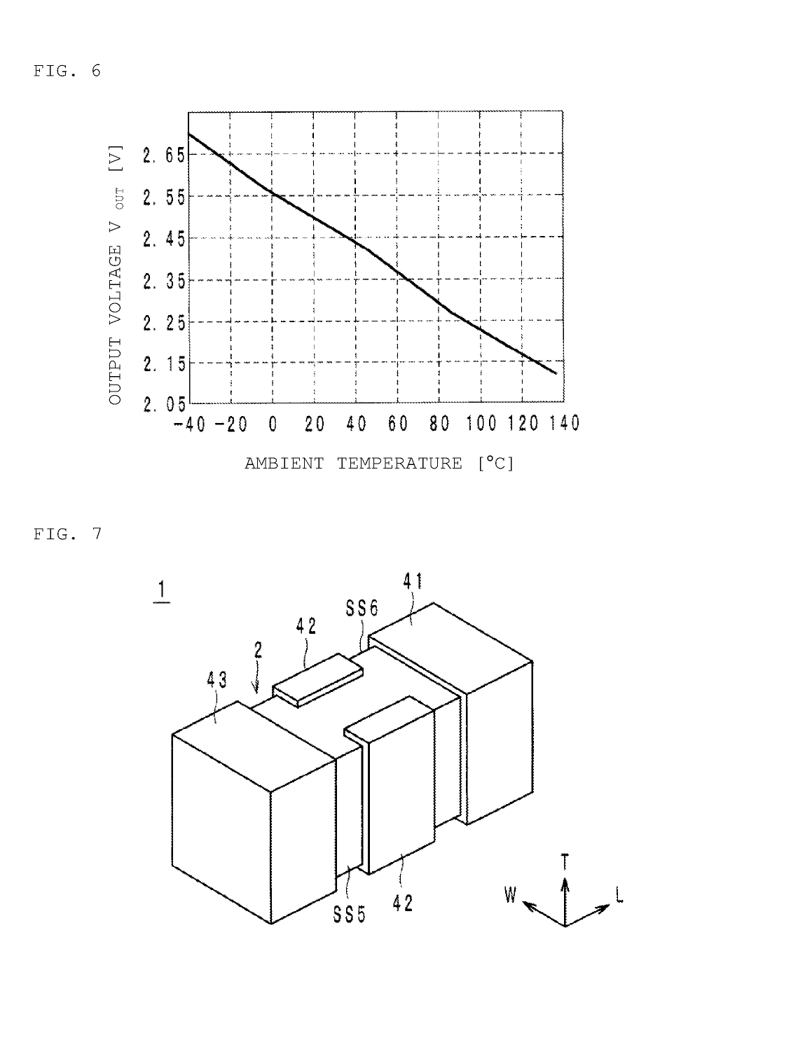

In this regard, FIG. 6 is a graph showing temperature characteristics of the output voltage V_{OUT} for the evaluation sample No. 1. From this measurement result, the inventors obtained ΔmV/K and R² as properties of the thermistor element 1. The ΔmV/K refers to the absolute value of the rate of change of the output voltage V_{OUT} (described later) in the operating temperature range (for example, from −40° C. to 125° C.) of the thermistor element 1. In addition, the R² refers to a correlation coefficient indicating the linearity in this operating temperature range. In regard to the evaluation sample No. 1, the ΔmV/K is about 3.2 which is large, and the R² is about 0.998 which is close to 1. Therefore, this evaluation sample No. 1 with high linearity is able to detect the ambient temperature at high resolution.

As described above, according to the present preferred embodiment, the thermistor element includes the thermistor sections 22, 23 that have different temperature coefficients α_{TH1} and α_{TH2}, and the internal electrodes 31 to 33 that vertically sandwich the thermistor sections. Further, when the constant voltage V_{CC} is supplied to the internal electrodes 31, 33, it is possible to extract, from the internal electrode 32, the output voltage V_{OUT} indicating the ambient temperature. As just described, according to the present preferred embodiment, it is possible to detect the ambient temperature with the single thermistor element 1, thus making it possible to dispose the element in a more limited space than ever before.

It is to be noted that the T dimension and W dimension of the main body 2 have been both explained as preferably being about 0.28 mm in the preferred embodiment described above. However, the present invention is not limited to this preferred embodiment, and the attempt to achieve a lower-profile element by making the T dimension of the main body 2 smaller than the W dimension, for example, about 0.15 mm is preferred, because the attempt makes it easier to determine which side surface of the main body 2 the external electrode 42 is formed on in the process of manufacturing the thermistor element 1.

In addition, the second external electrode 42 preferably vertically crosses a central portion of the side surface SS5 (see FIG. 3) in the L axis direction in the preferred embodiment described above. However, the present invention is not limited to this preferred embodiment, and when the internal electrode 32 is exposed from the back surface of the main body 2, the second external electrode 42 may be provided on the side surface SS6 (see FIG. 3).

In addition, when the internal electrode 32 is exposed from both the side surfaces SS5, SS6 of the main body 2, the second external electrode 42 may be provided on each of the side surfaces SS5, SS6 as shown in FIG. 7.

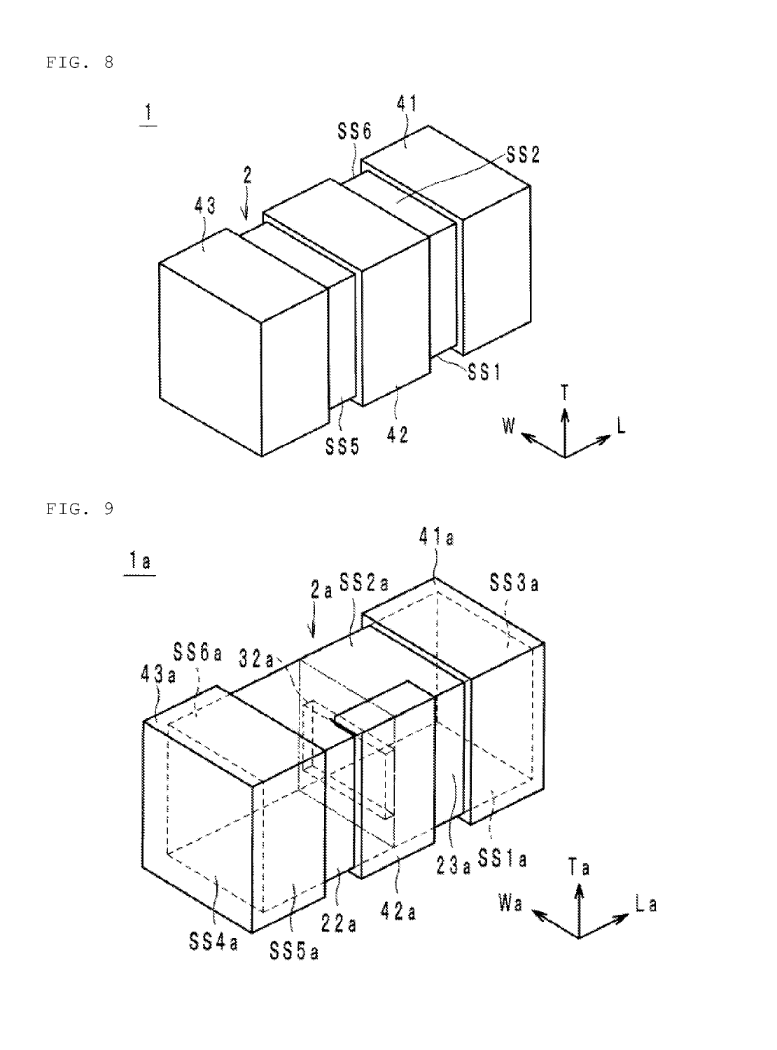

Furthermore, when the internal electrode 32 is exposed from both the side surface SS5 and/or side surface SS6 of the main body 2, the second external electrode 42 may extend around the side surfaces SS1, SS5, SS2, SS6 in this order as shown in FIG. 8.

The provision of the second external electrode 42 on more than one side surface as described above is preferred, because of increasing the mounting surface of the thermistor element 1 to a circuit substrate or the like. As a result, it is possible to reduce or prevent, for example, the problem of rotating the thermistor element 1 in mounting onto a circuit board or the like, thus failing to connect the second external electrode 42 to a land.

It is to be noted that the dimensions of the main body are not limited to the values mentioned above, but the size 3225, size 3216, size 2012, size 1608, size 1005, size 0603, and size 0402 may be adopted. Details of the size 3225 will be described as a representative of these seven types. In regard to the size 3225, the designed target value of the L dimension is, for example, about 3.2 mm, and the designed target value of the W dimension is, for example, about 2.5 mm. It is to be noted that the target value of the T dimension is not particularly restricted, but preferably designed to a value that is different from the W dimension (for example, about 1.0 mm or less). Also in regard to the size 3225, the L dimension, the W dimension, and the T dimension are not always accurately the numerical values mentioned above, with tolerances. In regard to the other six types of sizes, there are details as listed in Table 2 below.

TABLE 2
Table 2: Size of Main Body 2

| | | | T Dimension |
|---|---|---|---|
| | L Dimension | W Dimension | [mm] |
| | [mm] | [mm] | (Example of |
| | (Designed | (Designed | Designed |
| Size | Target Value) | Target Value) | Target Value) |
| 3225 | 3.2 | 2.5 | 1.0 |
| 3216 | 3.2 | 1.6 | 1.0 |
| 2012 | 2.0 | 1.2 | 1.0 |
| 1608 | 1.6 | 0.8 | 0.4 |
| 1005 | 1.0 | 0.5 | 0.25 |
| 0603 | 0.6 | 0.3 | 0.15 |
| 0402 | 0.4 | 0.2 | 0.1 |

In addition, the evaluation sample No. 1 has been evaluated for various types of properties in the preferred embodiment described above. The other evaluation samples are also, in regard to the features in terms of configuration, equivalent to the evaluation sample No. 1. Therefore, also for the other evaluation samples, it is possible to detect the ambient temperature at a high resolution with the single element, and the temperature characteristics of the output voltage has linearity increased.

In addition, an NTC thermistor has been exemplified as the thermistor element 1 in the preferred embodiments described above. However, the present invention is not limited to the preferred embodiments described herein, and the thermistor element 1 may be a PTC thermistor with a positive temperature coefficient, for example.

### Second Preferred Embodiment

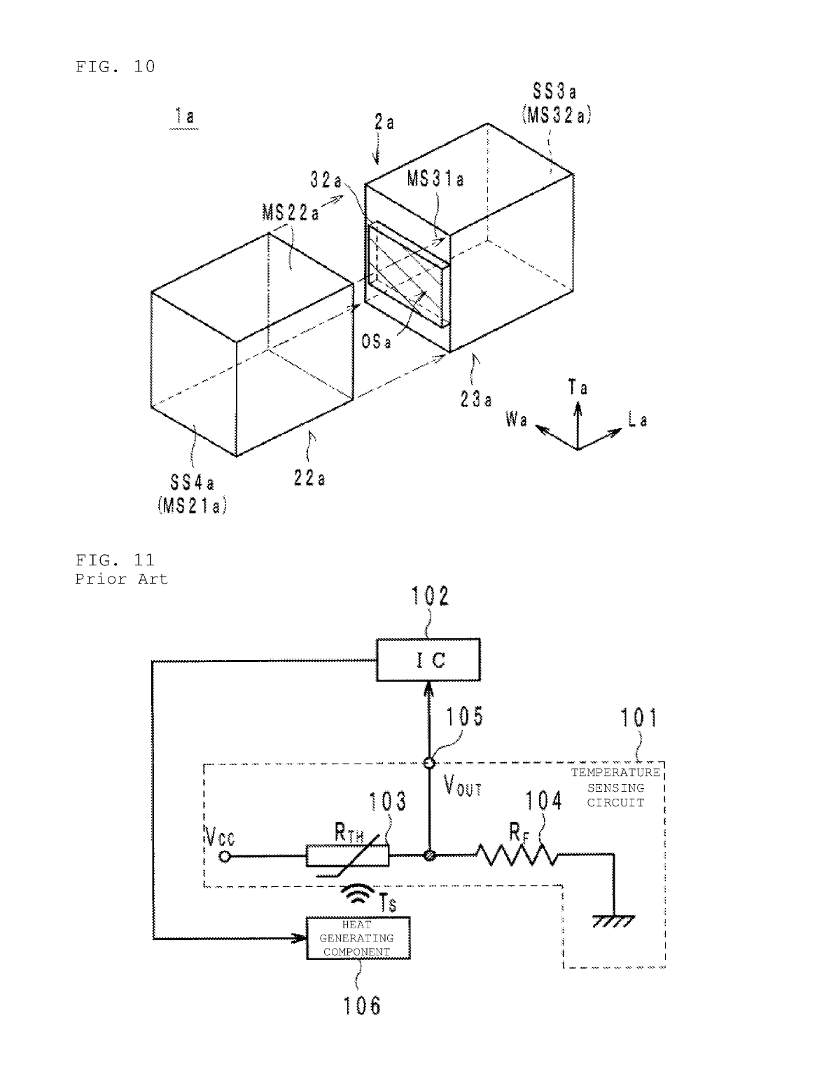

Next, a thermistor element 1a according to a second preferred embodiment of the present invention will be described in detail with reference to FIGS. 9 and 10.

First, the La axis, Wa axis, and Ta axis shown in FIGS. 9 and 10 will be described. The La axis direction indicates a direction in which a second thermistor section 23a is stacked on the basis of a first thermistor section 22a, and indicates a horizontal direction of the thermistor element 1a. This La axis direction refers to a second example of the first direction. The Wa axis direction indicates a front-back direction of the thermistor element 1a. The Ta axis direction indicates a vertical direction of the thermistor element 1a. Hereinafter, for the sake of explaining the present preferred embodiment, the first direction is denoted by La as a reference symbol.

FIG. 9 is a perspective view of a finished product of the thermistor element 1a, and FIG. 10 is an exploded perspective view of a main body 2a of the thermistor element 1a. In FIGS. 9 and 10, the thermistor element 1a, which is, for example, an NTC thermistor, includes at least the thermistor main body 2a, an internal electrode 32a, a first external electrode 41, a second external electrode 42a, and a third external electrode 43a.

The main body 2a has a substantially cuboid shape including six side surfaces SS1a to SS6a, with a predetermined size (see the first preferred embodiment). The side surfaces SS1a, SS2a define and function as, for example, the bottom surface and top surface of the main body 2a, which are mutually opposed in the Ta axis direction. The side surfaces SS3a, SS4a define and function as, for example, the right end surface and left end surface of the main body 2a, which are mutually opposed in the first direction La. The side surfaces SS5a, SS6a define and function as, for example, the front surface and back surface of the main body 2a, which are mutually opposed in the Wa axis direction.

In addition, the main body 2a includes the first thermistor section 22a and second thermistor section 23a stacked in the first direction La. Specifically, there is a third principal surface MS31a of the thermistor section 23a in contact with a second principal surface MS22a of the thermistor section 22a. It is to be noted that the boundaries between the two thermistor sections 22a, 23a that are adjacent to each other in the first direction La are shown by dashed-two dotted lines in an imaginary fashion in FIG. 9.

The thermistor sections 22a, 23a have, as with the thermistor sections 22, 23 according to the first preferred embodiment, negative temperature coefficients α_{TH1}, α_{TH2}, and B(25/50)_{TH1} and B(25/50)_{TH2}.

The internal electrode 32a, which is a second example of the second electrode, refers to a planar electrode interposed between the thermistor sections 22a, 23a. In addition, the internal electrode 32a extends from the side surface SS5a of the main body 2 in the Wa axis direction between the thermistor sections 22a, 23a. Furthermore, the internal electrode 32a is, for electrical connection to the after-mentioned external electrode 42a, exposed from the main body 2, for example, at the side surface SS5a of the main body 2a, but the other portion is covered with the main body 2a. It is to be noted that the internal electrode 32a is shown by dashed lines in FIG. 9.

The external electrodes 41a to 43a respectively have the same configuration as the external electrodes 41 to 43 according to the first preferred embodiment.

To explain more specifically, the external electrode 41a, which is a second example of the third electrode, is mostly provided on the side surface SS3a of the main body 2a (that is, a fourth principal surface MS32a of the thermistor section 23a). This external electrode 41a covering the right end of the main body 2a is exposed externally from the main body 2a.

The external electrode 42a is mainly provided on the side surface SS5a of the main body 2a. This external electrode 42a crosses, in the Ta axis direction, a central portion of the side surface SS5a in the L axis direction, and is electrically connected to the internal electrode 32a.

The external electrode 43a, which is a second example of the first electrode, is mostly provided on the side surface SS4a of the main body 2a (that is, a first principal surface 21a of the first thermistor section 22a). This external electrode 43a covering the left end of the main body 2a is exposed externally from the main body 2a.

Next, the arrangement relationship between the internal electrode 32a and the external electrodes 41a, 43a will be described in detail. The internal electrode 32a is spaced apart in a first direction La just at distances of approximately d₁, d₂ on the basis of the external electrodes 41a, 43a, and overlapped with the external electrodes 41a, 43a just of an area OSa (see a shaded area) in planar view from the first direction La. It is to be noted that the external electrodes 41a, 43a also include the overlap portion in fact, but for the convenience of illustration, the internal electrode 32a is only shown with hatching.

The thermistor element 1a configured as described above also achieves an advantageous effect similar to that of the first preferred embodiment

Thermistor elements according to various preferred embodiments of the present invention can be disposed in a limited space, and are preferred for an NTC thermistor or a PTC thermistor.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A thermistor element comprising:
a main body including a first thermistor section with first and second principal surfaces opposed to each other, and a second thermistor section with third and fourth principal surfaces opposed to each other, the second thermistor section stacked on the first thermistor section so that the third principal surface contacts with the second principal surface;
a first electrode located on the first principal surface and exposed externally from the main body;
a second electrode interposed between the second and third principal surfaces and exposed externally from the main body, the second electrode overlapped with the first electrode in planar view from a first direction of the second thermistor section to the first thermistor section; and
a third electrode located on the fourth principal surface and exposed externally from the main body, the third electrode overlapped with the second electrode in planar view from the first direction; wherein
a temperature coefficient α_{TH1} of a portion between the first and second electrodes in the first thermistor section is different from a temperature coefficient α_{TH2} of a portion between the second and third electrodes in the second thermistor section.

2. The thermistor element according to claim 1, wherein
the main body has a cuboid or substantially cuboid shape including first and second side surfaces opposed to each other in the first direction, third and fourth side surfaces opposed to each other in a second direction perpendicular or substantially perpendicular to the first direction, and fifth and sixth side surfaces opposed to each other in a third direction perpendicular or substantially perpendicular to the first and second directions;
the first electrode is a first internal conductor extending in the second direction on the first principal surface and exposed externally from the third side surface of the main body;
the second electrode is a second internal conductor extending in the third direction between the second and third principal surfaces and exposed externally from at least one of the fifth and sixth side surfaces of the main body;
the third electrode is a third internal conductor extending in a direction opposite to the second direction on the fourth principal surface and exposed externally from the fourth side surface of the main body;
the thermistor element further comprises:
first and third external electrodes located on the third and fourth side surfaces to be electrically connected to the first and third internal conductors; and
a second external electrode located on at least one of the fifth and sixth side surfaces to be electrically connected to the second internal conductor.

3. The thermistor element according to claim 2, wherein when a dimension along the first direction of the main body is referred to as a T dimension, a dimension along the third direction of the main body is referred to as a W dimension, and the T dimension is smaller than the W dimension.

4. The thermistor element according to claim 2, wherein the second external electrode is located on each of the fifth and sixth side surfaces.

5. The thermistor element according to claim 2, wherein the second external electrode extends around the first, fifth, second, and sixth side surfaces.

6. The thermistor element according to claim 1, wherein the main body has a cuboid shape or a substantially cuboid shape.

7. The thermistor element according to claim 1, wherein the main body has dimensions of about 0.56 mm, about 0.28 mm, and about 0.28 mm.

8. The thermistor element according to claim 1, further comprising a third thermistor section and a fourth thermistor section stacked in an order of the third thermistor section, the first thermistor section, the second thermistor section, and the fourth thermistor section from a bottom of the main body to a top of the main body.

9. The thermistor element according to claim 1, wherein each of the temperature coefficient α_{TH1} and the temperature coefficient α_{TH2} is a negative temperature coefficient.

10. The thermistor element according to claim 1, wherein each of the first thermistor section and the second thermistor section has a resistance value that decreases in a linear or substantially linear manner.

11. The thermistor element according to claim 1, wherein the first thermistor section has a composition different from that of the second thermistor section.

12. The thermistor element according to claim 8, wherein a composition of the first and the third thermistor sections are the same as each other, and a composition of the second and the fourth thermistor sections are the same as each other and different from the composition of the first and third thermistor sections.

13. The thermistor element according to claim 8, wherein the first and the third thermistor sections are defined by a same sintered oxide body, and the second and the fourth thermistor sections are defined by a same sintered oxide body that is different from the sintered oxide boy of the first and third thermistor sections.

14. The thermistor element according to claim 2, wherein each of the first, second and third external electrodes include a metal base layer and first and second plated layers.

15. The thermistor element according to claim 2, wherein the second external electrode vertically crosses a side surface of the main body and does not contact the first external electrode.

16. The thermistor element according to claim 1, wherein the main body has dimensions of about 0.56 mm, about 0.15 mm, and about 0.15 mm.

17. The thermistor element according to claim 1, wherein the thermistor element defines one of an NTC thermistor and a PTC thermistor.
